(19) United States
(12) Patent Application Publication
(10) Pub. No.: US 2015/0339016 A1
(43) Pub. Date: Nov. 26, 2015

(54) TAB CREATION METHOD, DEVICE, AND TERMINAL

(71) Applicant: Xiaomi Inc., Beijing (CN)

(72) Inventors: Junjie DONG, Beijing (CN); Xingping Zheng, Beijing (CN)

(73) Assignee: Xiaomi Inc.

(21) Appl. No.: 14/585,796

(22) Filed: Dec. 30, 2014

Related U.S. Application Data
(63) Continuation of application No. PCT/CN2014/089198, filed on Oct. 22, 2014.

(30) Foreign Application Priority Data
May 21, 2014 (CN) 201410216429.4

(51) Int. Cl. G06F 3/0483; G06F 3/0484

(52) U.S. Cl. CPC G06F 3/0483; G06F 3/04842

(57) ABSTRACT

A tab creation method is provided. The method includes receiving a tab creation request which contains tab content and a theme identification of an application. The theme identification is an identification of a theme currently used in the application. The method further includes reading tab attribute information from theme information indicated by the theme identification; determining a tab style consistent with the theme based on the tab attribute information; and creating a tab including the tab content in a tab bar based on the tab style.

### CROSS-REFERENCE TO RELATED APPLICATIONS

This application is a Continuation Application of International Application No. PCT/CN2014/089198, filed Oct. 22, 2014, which is based upon and claims priority to Chinese Patent Application No. 201410216429.4, filed May 21, 2014, the entire contents of all of which are incorporated herein by reference.

### TECHNICAL FIELD

The present disclosure generally relates to the field of computer technology and, more particularly, to a tab creation method, device, and terminal.

### BACKGROUND

In recent years, it has drawn much attention and become popular to personalize a display screen of a terminal. One of the important aspects is to personalize a theme of an application. However, conventional customization of color, picture, character and the like of an application interface based on a theme may not meet users' personalization needs, because users have been demanding high level personalization requests, such as modifying the position of an element of the application interface.

A tab is one of the elements of an application interface. Generally, a terminal may create a tab with the following process: the terminal receives a tab creation request, reads pre-determined tab style information, which indicates that a width of the tab is defined by equally dividing a width of a tab bar, and then creates a tab in the tab bar with the defined width.

### SUMMARY

According to a first aspect of the present disclosure, there is provided a tab creation method, comprising: receiving a tab creation request which contains tab content and a theme identification of an application, the theme identification being an identification of a theme currently used in the application; reading tab attribute information from theme information indicated by the theme identification; determining a tab style consistent with the theme based on the tab attribute information; and creating a tab including the tab content in a tab bar based on the tab style.

According to a second aspect of the present disclosure, there is provided a terminal, comprising: a processor; a memory configured to store instructions executable by the processor; wherein the processor is configured to perform: receiving a tab creation request which contains tab content and a theme identification, the theme identification being an identification of a theme currently used in the application; reading tab attribute information from theme information indicated by the theme identification; determining a tab style consistent with the theme based on the tab attribute information; and creating a tab including the tab content in a tab bar based on the tab style.

According to a third aspect of the present disclosure, there is provided a non-transitory computer-readable storage medium having stored therein instructions that, when executed by a processor of a mobile terminal, cause the mobile terminal to perform a tab creation method, the method comprising: receiving a tab creation request which contains tab content and a theme identification of an application, the theme identification being an identification of a theme of the application currently in use; reading tab attribute information from theme information indicated by the theme identification; determining a tab style consistent with the theme based on the tab attribute information; and creating a tab including the tab content in a tab bar based on the tab style.

It will be appreciated that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a tab creation method, according to an exemplary embodiment.

FIG. 2A is a flow chart of a tab creation method, according to an exemplary embodiment.

FIG. 2B is a schematic diagram showing a portion of display screen of a terminal, according to an exemplary embodiment.

FIG. 2C is a schematic diagram showing a portion of display screen of a terminal, according to an exemplary embodiment.

FIG. 2D is a schematic diagram showing a portion of display screen of a terminal, according to an exemplary embodiment.

FIG. 2E is a schematic diagram showing a portion of display screen of a terminal, according to an exemplary embodiment.

FIG. 3 is a block diagram of a tab creation device, according to an exemplary embodiment.

FIG. 4 is a block diagram of a tab creation device, according to an exemplary embodiment.

FIG. 5 is a block diagram of a tab creation device, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

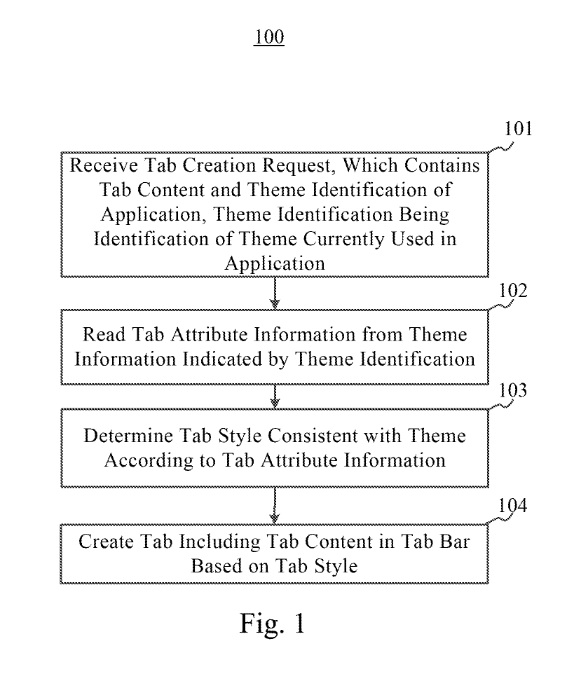

FIG. 1 is a flow chart of a tab creation method 100, according to an exemplary embodiment. Referring to FIG. 1, the tab creation method 100, which may be performed by a terminal, includes the following steps.

In step 101, a tab creation request is received by the terminal. The request contains tab content and an identification of a theme of an application. The theme identification is an identification of the theme currently used in the application.

In exemplary embodiments, a tab is configured to identify an application interface of an application, and tab content is configured to indicate content of the application interface. A theme identification of an application is configured to identify the theme currently used in the application.

In step 102, tab attribute information is read from theme information indicated by the theme identification.

In exemplary embodiments, to create a tab style consistent with the theme of an application, the tab style may be preset based on the theme of the application. In addition, tab attribute information for defining the tab style may be added into theme information, so that the tab attribute information can be read by the terminal from the theme information after the terminal determines the currently used theme of the application based on the theme identification contained in a tab creation request.

In step 103, a tab style consistent with the theme may be determined based on the tab attribute information. For example, the terminal determines the tab style based on parameters defined in the tab attribute information.

In step 104, a tab including the tab content is created in the tab bar based on the tab style. For example, the terminal creates the tab in the tab bar based on the determined tab style and adds the tab content contained in the tab creation request into the created tab.

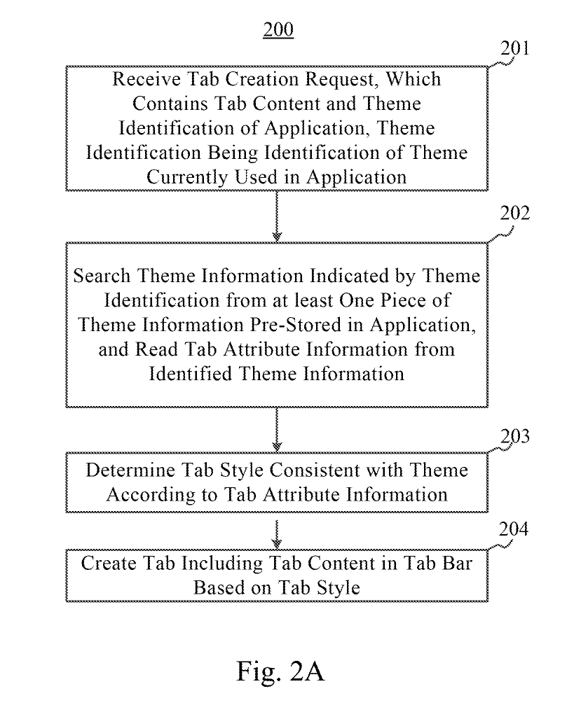

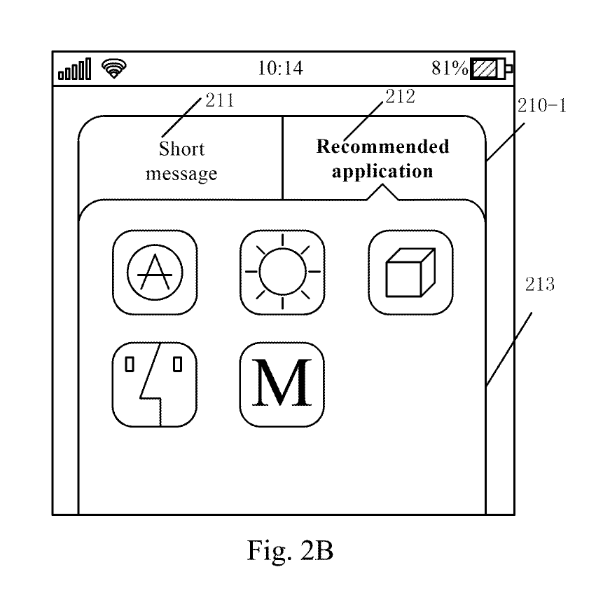

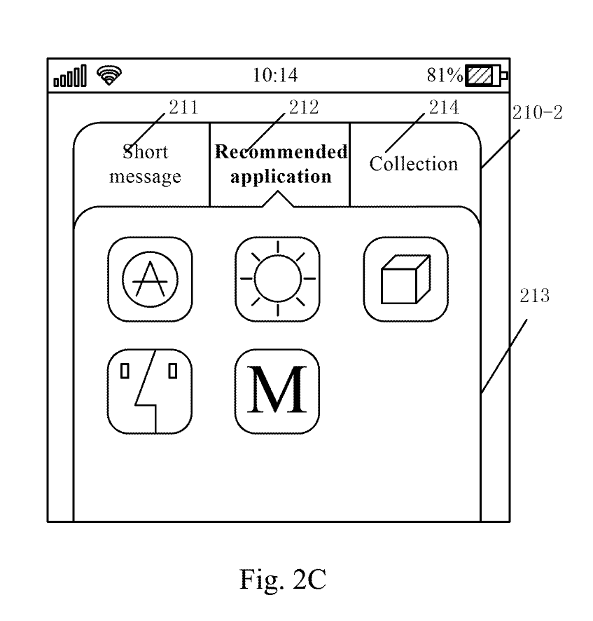

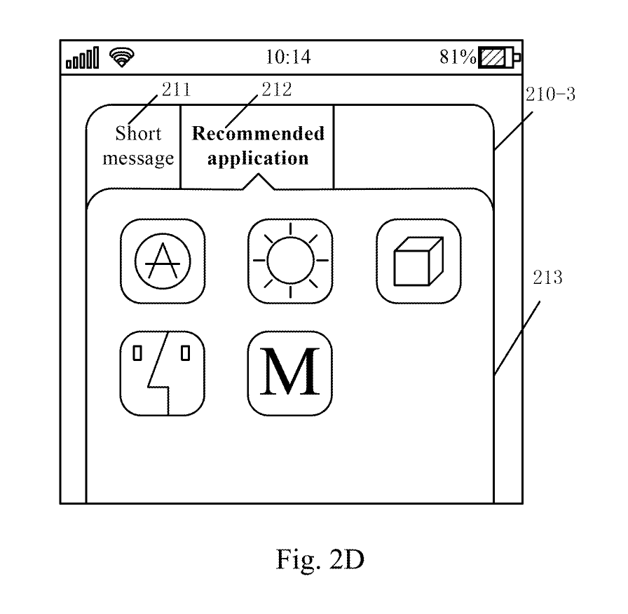

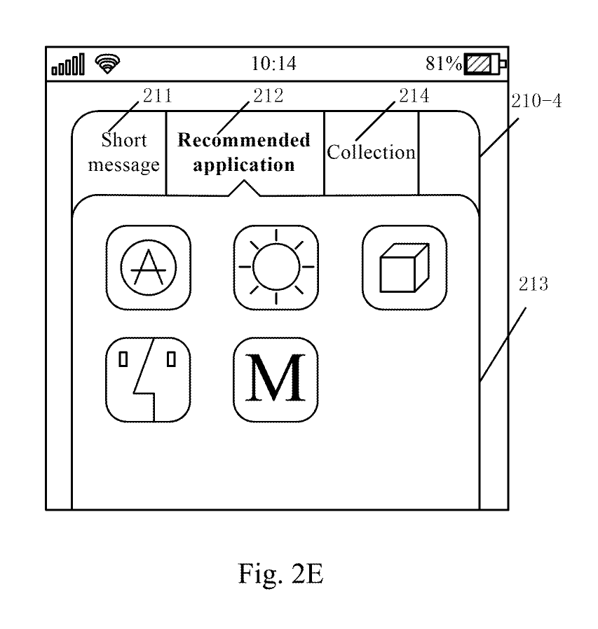

FIG. 2A is a flow chart of a tab creation method 200, according to an exemplary embodiment. Referring to FIG. 2A, the tab creation method 200, which may be performed by a terminal, includes the following steps.

In step 201, a tab creation request is received by the terminal as a user device. The request contains tab content and an identification of a theme of an application. The theme identification is an identification of the theme currently used in the application.

In exemplary embodiments, a tab is configured to identify an application interface of an application, and tab content is configured to indicate content of the application interface. For example, an application may include first and second application interfaces, the first application interface including other applications recommended by the current application, and the second application interface including short messages stored in the application. The terminal may create first and second tabs for the first and second application interfaces, respectively, name the first tab of the first application interface as, e.g., “Recommended Application,” and name the second tab of the second application interface as, e.g., “Short Messages.”

Referring to FIG. 2B, a tab bar 210-1 of an application includes a first tab 211 and a second tab 212. The tab content of the first tab 211 is “Short Message,” and the tab content of second tab 212 is “Recommended Application.” An application interface 213 corresponding to the second tab 212 is shown if a user clicks the second tab 212. For example, the application interface 213 shows icons of five recommended applications.

In exemplary embodiments, a theme identification of an application is configured to identify the theme currently used in the application. A tab creation request may be received either after or before the terminal adds tab content into a newly-created application interface. The timing for sending or receiving a tab creation request is not limited.

Referring back to FIG. 2A, in step 202, after receiving the tab creation request, the terminal may search for theme information indicated by the theme identification from at least one piece of theme information pre-stored in an application, and read tab attribute information from the identified theme information. The tab attribute information may include a rule for determining a width of the tab and a manner for arranging the tab in a tab bar.

In exemplary embodiments, to make a tab style of the tab consistent with a theme of the application, the tab style may be preset based on the theme of the application, and the tab attribute information for defining the tab style may be added into theme information. After the terminal reads the theme identification of the currently used theme from the tab creation request, the terminal may perform a search in the pre-stored theme information for theme information indicated by theme identification of the application. The terminal may read the tab attribute information from the identified theme information.

In exemplary embodiments, the tab style may include a tab width, a manner for arranging the tab, a font, a font size, a font color, a background color, etc. The font, the font size, the font color, and the background color may be defined in a theme of the application. In the illustrated embodiment, the tab style includes a tab width and a rule for arranging the tab in a tab bar, and the tab attribute information includes a rule for determining the tab width and a manner for arranging the tab in a tab bar.

In some embodiments, based on the rule, the terminal may determine a tab width based on a width occupied by a tab content or use a preset width as the tab width. The terminal may execute instructions to arrange new tabs so that they are aligned to the left, aligned to the right, or to the center of the tab bar. In other embodiments, based on the rule, the terminal may set a tab width using the maximum available width of a tab bar, and arrange the tabs in a dispersive manner.

For example, the following are three exemplary rules for determining a tab width, referred hereafter as tab width determination rules. The present disclosure is not limited to these rules. One of ordinary skill in the art may understand that various implementation may be derived from these rules.

According to a first tab width determination rule, a tab width may be determined based on a width occupied by tab content. For example, tab content is configured to indicate the content of an application interface. The terminal is configured to display the tab content of a tab so that a user may know the application interface that corresponds to the tab. Accordingly, the terminal may determine a tab width based on a width occupied by the tab content. Also for example, different manners for arranging the tab having a tab width determined based on a width occupied by the tab content may be used, including, for example, aligning the tab to the left, the right, or the center of a tab bar.

According to a second tab width determination rule, a preset width may be used as a tab width. For example, the terminal may store a plurality of preset widths and select one of them as the tab width to create a tab. Because the second tab width determination rule can determine a tab width without much calculation, it may not only save processing resource of the terminal, but also reduce the time required to create a tab. Also for example, different manners for arranging a tab created based on a preset width may be used, including, for example, aligning the tab to the left, the right, or the center of a tab bar.

According to a third tab width determination rule, the terminal may set a tab width based on the maximum available width of a tab bar. The maximum available width refers to a maximum width that a tab bar can offer to create a tab. A tab created based on the maximum available width of a tab bar may be arranged in a dispersive manner in the tab bar.

For example, the width of a tab bar can be considered a tab width if the tab bar does not include a created tab yet. As another example, a width of a newly created tab may be one third of the width of a tab bar if the tab bar includes two existing tabs. FIG. 2B shows a schematic diagram of the first tab bar 210-1, and FIG. 2C shows a schematic diagram of a second tab bar 210-2. Referring to FIG. 2B, the first tab bar 210-1 includes a first tab 211 and a second tab 212. The first tab bar 210-1 is divided by the first tab 211 and the second tab 212 in a dispersive manner. In one exemplary embodiment, as shown in FIG. 2B, the tab width of each of the first tab 211 and the second tab 212 is equal to a half of the whole width of the first tab bar 210-1. Referring to FIG. 2C, the second tab bar 210-2 includes the first tab 211, the second tab 212, and a third tab 214. The second tab bar 210-2 is divided by the first tab 211, the second tab 212, and the third tab 214 in a dispersive manner. In one exemplary embodiment, as shown in FIG. 2C, the tab width of each of the first tab 211, the second tab 212, and the third tab 214 is equal to one third of the whole width of second tab bar 210-2.

In exemplary embodiments, when at least two width determination rules are available, the terminal may be configured to select one of them consistent with a theme. Similarly, when at least two manners for arranging a tab are available, the terminal may be configured to select one of them consistent with a theme. Thus, by providing different width determination rules and different rules for arranging a tab in a tab bar, the terminal may arbitrarily combine one width determination rule with one rule for arranging the tabs, thereby enriching the tab style.

Referring back to FIG. 2A, in step 203, a tab style consistent with the theme may be determined based on tab attribute information.

The terminal may read a width determination rule and a tab arrangement manner as defined in tab attribute information, and determine a tab width based on the width determination rule, and determine the tab style based on the tab width and the tab arrangement manner.

In exemplary embodiments, the terminal may read the width determination rule directly from tab attribute information if the tab attribute information includes a width determination rule. Alternatively, the terminal may read from tab attribute information an index for identifying a width determination rule and search for a rule corresponding to the index. A pre-determined relationship between width determination rules and indexes is stored in a recording medium of the terminal. As another example, the terminal may employ a default width determination rule if the tab attribute information does not include a width determination rule. The terminal may obtain a tab arrangement manner based on the tab attribute information in a way similar to the method of acquiring a width determination rule described above.

In some embodiments, a tab style defined consistent with the theme may be determined based on tab attribute information. For example, the terminal may determine a tab style by 1) calculating a tab width based on the tab content if the width determination rule specifies that the tab width is determined based on the width occupied by the tab content; and 2) determining the tab style based on the tab width and a tab arrangement manner.

As another example, if a tab width is determined based on the width occupied by the tab content, the terminal may read the tab content from a tab creation request, calculate the tab width based on the tab content, and determine a tab style based on the calculated tab width and a tab arrangement manner.

In some embodiments, calculating the tab width based on the tab content may include: 1) calculating a content width occupied by the tab content; and 2) determining the content width as the tab width; or detecting whether the content width is greater than a pre-determined minimum width and smaller than a pre-determined maximum width, and determining to use the content width as the tab width if the content width is greater than the pre-determined minimum width and smaller than the pre-determined maximum width, or determining to use the pre-determined minimum width or the pre-determined maximum width as the tab width if the content width is smaller than the pre-determined minimum width or greater than the pre-determined maximum width, respectively.

In exemplary embodiments, tab content may include at least one of a character or a picture. Thus, the terminal may calculate the width of each character and each picture, and determine the tab width based on a total width of all characters and/or pictures.

After determining the content width occupied by tab content, the terminal may determine to use the content width as the tab width. Alternatively, the terminal may set a minimum width and a maximum width to be the tab width, and determine the tab width to be a width between the minimum width and the maximum width.

In determining the tab width from a width range between the minimum width and the maximum width based on the content width, the terminal may determine whether the content width is greater than the minimum width and smaller than the maximum width, and determine to use the content width as the tab width if the content width is greater than the minimum width and smaller than the maximum width, or determine to use one of the minimum width or the maximum width that is close to the content width as the tab width.

In some embodiments, determining to use the minimum width or the maximum width as the tab width may include: 1) comparing an absolute value of a first difference with an absolute value of a second difference, the first difference being acquired by subtracting the content width from the minimum width, and the second difference being acquired by subtracting the content width from the maximum width; 2) determining to use the maximum width as the tab width if the absolute value of the first difference is greater than the absolute value of the second difference; and 3) determining to use the minimum width as the tab width if the absolute value of the first difference is smaller than the absolute value of the second difference.

The terminal may acquire the first difference by subtracting the content width from the minimum width, acquire the second difference by subtracting the content width from the maximum width, and compare the absolute value of the first difference with the absolute value of the second difference. If the absolute value of the first difference is greater than the absolute value of the second difference, the terminal can determine that content width is closer to the maximum width than to the minimum width. Based on the determination, the terminal can determine to use the maximum width as the tab width. If the absolute value of the first difference is smaller than the absolute value of the second difference, the terminal can determine that the content width is closer to the minimum width than to the maximum width. Based on the determination, the terminal can determine to use the minimum width as the tab width.

Generally, the tab width increases as the width of the tab content increases. Referring to a schematic diagram of a third tab bar 210-3 as shown in FIG. 2D, the tab content of the first tab 211 is “Short message”, and the tab content of the second tab 212 is “Recommended application.” The text length of “recommended application” is greater than that of “short message”. Therefore, a width occupied by the second tab 212 may be greater than that occupied by the first tab 211, i.e., the tab width of the second tab 212 may be greater than that of the first tab 211.

In some embodiments, a tab style consistent with the theme of the tab may be determined based on tab attribute information. An exemplary method to determine a tab style may include: 1) if the width determination rule is to use the maximum available width of a tab bar for tabs, dividing the whole width of a tab bar into equal widths for the tabs including a tab being created and at least one existing tab in the tab bar; and 2) determining a tab style based on the tab width and a tab arrangement manner.

For example, if the width determination rule is to use a maximum available width of the tab bar for tabs, the terminal may calculate a tab width based on the number of tabs included in the tab bar and the width of the tab bar, and determine a tab style based on the calculated tab width and a tab arrangement manner.

In calculation of the tab width of a new tab, for example, the terminal may add one to the number of the existing tabs in the tab bar, thus obtaining the total number of tabs. The tab width may be obtained by dividing the width of the tab bar by the total number of tabs. A tab style may be determined based on the calculated tab width and a tab arrangement manner.

Referring back to FIG. 2A, in step 204, a tab including tab content is created in a tab bar based on the tab style.

For example, the terminal may create a tab in the tab bar based on the determined tab style and add the tab content contained in the tab creation request into the created tab. A new tab may be added into a tab bar for display if it does not affect a width or style of existing tabs in the tab bar. However, if the new tab affects the existing tabs in the tab bar, the terminal may adjust the existing tabs to accommodate the new tab.

Next, exemplary tab creation processes are illustrated below. Here, the example is to create a new tab with the tab content being “Collection” in a tab bar that includes existing tabs, such as the first tab 211 and the second 212 (FIG. 2A).

In one exemplary embodiment, the width determination rule specifies to use the maximum available width of a tab bar as a tab width for the newly created tab as defined in tab attribute information, and the tab arrangement manner is to arrange the tabs in a dispersive manner. Referring to FIG. 2B, the first tab bar 210-1 includes the first tab 211 and the second tab 212 before the tab 214 is created. The tab bar 210-1 is equally divided in half for the first tab 211 and the second tab 212. Referring to FIG. 2C, the second tab bar 210-2 includes the newly created tab 214. The second tab bar 210-2 includes the first tab 211, the second tab 212 and the third tab 214, and is equally divided in three parts for the first tab 211, the second tab 212, and the third tab 214.

In one exemplary embodiment, the width determination rule is to determine a tab width based on a width occupied by tab content, as defined in tab attribute information, the tab arrangement manner is to align tabs to the left of the tab bar. Referring to FIG. 2D, the third tab bar 210-3 includes the first tab 211 and the second tab 212 before the tab 214 is created. As the tab content of the first tab 211 is less than that of the second tab 212, the tab width of the first tab 211 is less than that of the second tab 212. The first tab 211 and the second tab 212 are arranged to align to the left in third tab bar 210-3.

Referring to FIG. 2E, a fourth tab bar 210-4 includes the newly created tab 214. The fourth tab bar 210-4 includes the first tab 211, the second tab 212, and the third tab 214. As the length of tab content of the third tab 214 is substantially equal to that of the first tab 211 and less than that of the second tab 212, the tab width of the third tab 214 may be substantially equal to that of the first tab 211 and less than that of the second tab 212. The first tab 211, second tab 212, and third tab 214 are arranged to align to the left in the fourth tab bar 210-4.

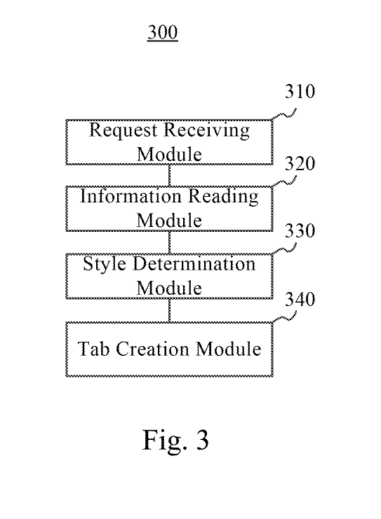

FIG. 3 is a block diagram of a tab creation device 300, according to an exemplary embodiment. Referring to FIG. 3, the tab creation device 300, which may be a terminal, includes a request receiving module 310, an information reading module 320, a style determination module 330, and a tab creation module 340.

The request receiving module 310 is configured to receive a tab creation request, which contains tab content and an identification of a theme of an application. The theme identification is an identification of the theme currently used in the application.

The information reading module 320 is configured to read tab attribute information from theme information as indicated in the theme identification.

The style determination module 330 is configured to determine a tab style consistent with the theme based on the tab attribute information read by the information reading module 320.

The tab creation module 340 is configured to create a tab including the tab content in a tab bar based on the tab style determined by the style determination module 330.

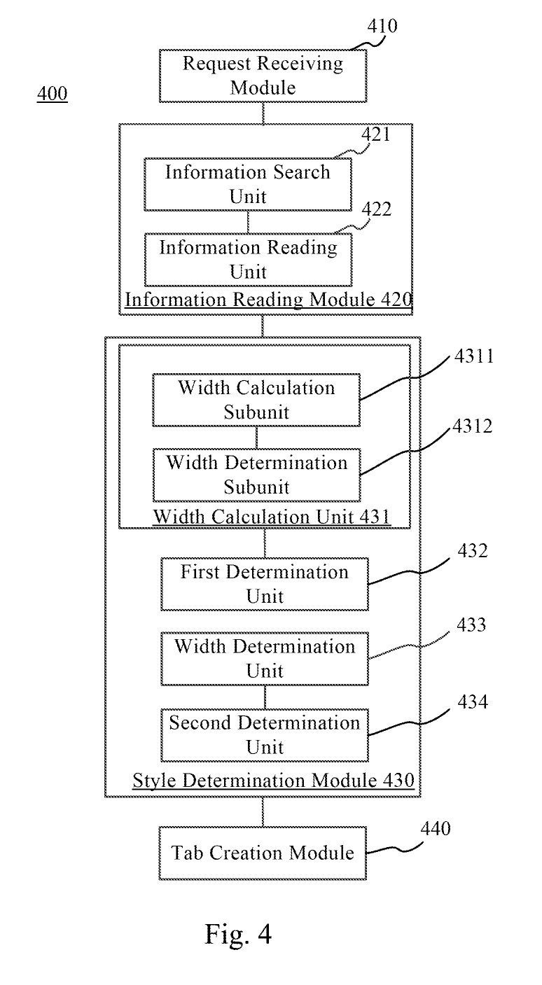

FIG. 4 is a block diagram of a tab creation device 400, according to an exemplary embodiment. Referring to FIG. 4, the tab creation device 400, which may be a terminal, includes a request receiving module 410, an information reading module 420, a style determination module 430, and a tab creation module 440.

The request receiving module 410 is configured to receive a tab creation request, which contains tab content and an identification of a theme of an application. The theme identification is an identification of the theme currently used in the application.

The information reading module 420 is configured to read tab attribute information from theme information as indicated in the theme identification.

The style determination module 430 is configured to determine a tab style consistent with the theme based on the tab attribute information read by information reading module 420.

The tab creation module 440 is configured to create a tab including the tab content in a tab bar based on the tab style determined by style determination module 430.

Optionally, the information reading module 420 may include an information search unit 421 and an information reading unit 422.

The information search unit 421 is configured to search for theme information indicated by the theme identification from at least one piece of theme information pre-stored in the application.

The information reading unit 422 is configured to read tab attribute information from the theme information identified by the information search unit 421. The tab attribute information includes a rule for determining a width of the tab and a manner for arranging the tab in the tab bar.

The width determination rule may be one that determines a tab width based on a width occupied by tab content or one that determines to use a preset width as the tab width. The manner for arranging a tab in a tab bar may be one that aligns the tabs to the left, the right, or the center of the tab bar.

Alternatively, the width determination rule may be one that determines a tab width based on the maximum available width of a tab bar, and the manner for arranging a tab in a tab bar may be arranging tabs in a dispersive manner.

In some embodiments, the style determination module 430 may include a width calculation unit 431 and a first determination unit 432.

The width calculation unit 431 is configured to calculate the tab width based on the tab content if the width determination rule is to determine the tab width based on the width occupied by the tab content.

The first determination unit 432 is configured to determine a tab style based on the tab width calculated by the width calculation unit 431 and a manner for arranging the tab in a tab bar.

In some embodiments, the width calculation unit 431 may include a width calculation subunit 4311 and a width determination subunit 4312. The width calculation subunit 4311 is configured to calculate a content width occupied by the tab content. The width determination subunit 4312 is configured to determine to use the content width calculated by the width calculation subunit 4311 as the tab width.

In one exemplary embodiment, the width determination subunit 4312 is configured to detect whether the content width calculated by the width calculation subunit 4311 is greater than a pre-determined minimum width and smaller than a pre-determined maximum width, determine to use the content width as the tab width if the content width is greater than the pre-determined minimum width and smaller than the pre-determined maximum width, and determine to use the pre-determined minimum width or the pre-determined maximum width as the tab width if the content width is smaller than the pre-determined minimum width or greater than the pre-determined maximum width.

In one exemplary embodiment, the width determination subunit 4312 is configured to: compare an absolute value of a first difference with an absolute value of a second difference, the first difference being acquired by subtracting the content width from a pre-determined minimum width, and the second difference being acquired by subtracting the content width from a pre-determined maximum width; determine to use the pre-determined maximum width as the tab width if the absolute value of the first difference is greater than the absolute value of the second difference; and determine to use the pre-determined minimum width as the tab width if the absolute value of the first difference is smaller than the absolute value of the second difference.

Optionally, the style determination module 430 may further include a width determination unit 433 and a second determination unit 434.

The width determination unit 433 is configured to determine to use a bisection width of a tab bar as the tab width for the newly created tab if the width determination rule is to determine the tab width based on the maximum available width of the tab bar. The bisection width is acquired by bisecting the width of a tab bar, which includes a tab being created and at least an existing tab in the tab bar.

The second determination unit 434 is configured to determine a tab style based on the tab width determined by width determination unit 433 and a manner for arranging the tab in a tab bar.

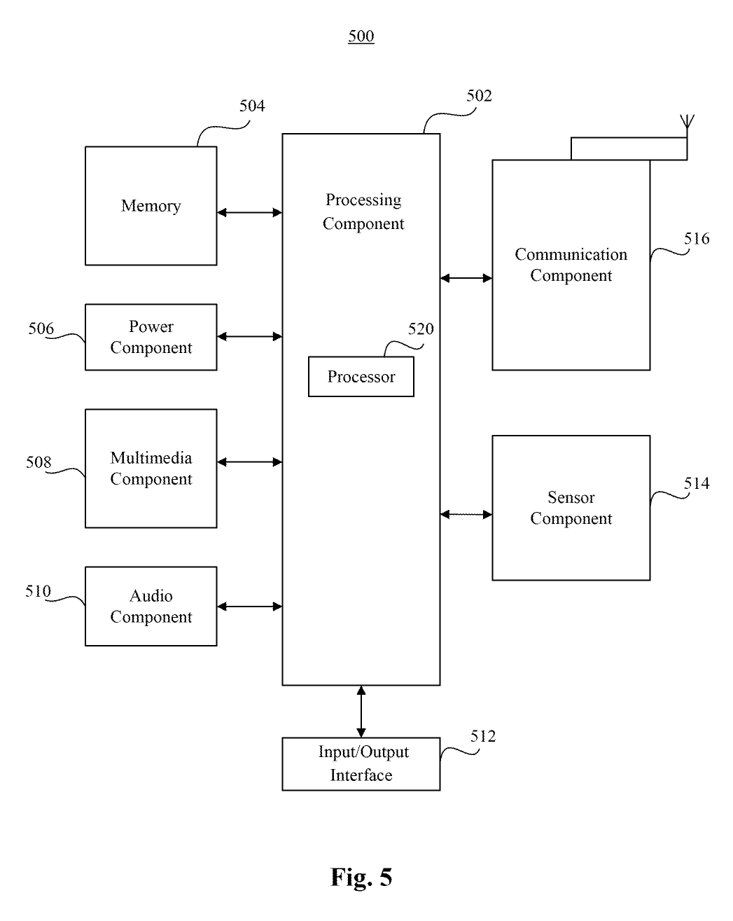

FIG. 5 is a block diagram of a terminal 500, according to an exemplary embodiment. For example, the terminal 500 may be a mobile phone, a computer, a digital broadcasting terminal, a messaging device, a game console, a tablet device, medical equipment, fitness equipment, a personal digital assistant, etc.

Referring to FIG. 5, the terminal 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the terminal 500, such as operations associated with display, telephone calls, data communications, camera operations and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the terminal 500. Examples of such data include instructions for any applications or methods operated on the terminal 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the terminal 500. The power component 506 may include a power management system, one or more power sources, and any other components associated with the generation, management, and distribution of power for the terminal 500.

The multimedia component 508 includes a screen providing an output interface between the terminal 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slides, and gestures on the touch panel. The touch sensors may not only sense a boundary of a touch or slide operation, but also sense a period of time and a pressure associated with the touch or slide operation. In some embodiments, the multimedia component 508 includes a front camera and/or a rear camera. The front camera and the rear camera may receive an external multimedia datum while the terminal 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the terminal 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the terminal 500. For instance, the sensor component 514 may detect an open/closed status of the terminal 500, relative positioning of components (e.g., the display and the keypad of the terminal 500), a change in position of the terminal 500 or a component of the terminal 500, a presence or absence of user contact with the terminal 500, an orientation or an acceleration/deceleration of the terminal 500, and a change in temperature of the terminal 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the terminal 500 and other devices. The terminal 500 can access a wireless network based on a communication standard, such as WiFi, 2G, 3G, etc. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable medium including instructions, such as included in the memory 504 and executable by the processor 520 in the terminal 500, for performing the above-described methods. For example, the non-transitory computer-readable storage medium may be a ROM, a RAM, a CD-ROM, a magnetic tape, a floppy disc, an optical data memory device, etc.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A tab creation method, comprising:
receiving a tab creation request which contains tab content and a theme identification of an application, the theme identification being an identification of a theme currently used in the application;
reading tab attribute information from theme information indicated by the theme identification;
determining a tab style consistent with the theme based on the tab attribute information; and
creating a tab including the tab content in a tab bar based on the tab style.

2. The method according to claim 1, wherein the reading of the tab attribute information comprises:
identifying the theme information indicated by the theme identification from at least one piece of theme information pre-stored in the application; and
reading the tab attribute information from the identified theme information, the tab attribute information including a width determination rule for determining a width of the tab and a manner for arranging the tab in the tab bar.

3. The method according to claim 2, wherein:
the width determination rule comprises one of determining a tab width based on a width occupied by tab content or determining to use a pre-determined width as a tab width, and the manner for arranging the tab in the tab bar comprises one of aligning the tab to the left, aligning the tab to the right, or aligning the tab to the center of the tab bar; or
the width determination rule is to determine a tab width based on a maximum available width of a tab bar, and the manner for arranging the tab is to arrange the tab in the tab bar in a dispersive manner.

4. The method according to claim 3, wherein the width determination rule is to determine the tab width based on a width occupied by tab content, and the determining of the tab style comprises:
calculating the tab width based on the tab content; and
determining the tab style based on the tab width.

5. The method according to claim 4, wherein the calculating of the tab width comprises:
calculating a content width occupied by the tab content; and
determining to use the content width as the tab width; or detecting whether the content width is greater than a pre-determined minimum width and smaller than a pre-determined maximum width, determining to use the content width as the tab width if the content width is greater than the pre-determined minimum width and smaller than the pre-determined maximum width, determining to use the pre-determined minimum width as the tab width if the content width is smaller than the pre-determined minimum width, and determining to use the pre-determined maximum width as the tab width if the content width is greater than the pre-determined maximum width.

6. The method according to claim 5, wherein the determining to use the pre-determined minimum width or the pre-determined maximum width as the tab width comprises:
comparing an absolute value of a first difference with an absolute value of a second difference, the first difference being acquired by subtracting the content width from the pre-determined minimum width, and the second difference being acquired by subtracting the content width from the pre-determined maximum width;
determining to use the pre-determined maximum width as the tab width if the absolute value of the first difference is greater than the absolute value of the second difference; and
determining to use the pre-determined minimum width as the tab width if the absolute value of the first difference is smaller than the absolute value of the second difference.

7. The method according to claim 3, wherein the width determination rule is to determine the tab width based on the maximum available width of the tab bar, and the determining of the tab style comprises:
determining the tab width by equally dividing a width of the tab bar based on a total number of tabs of the tab bar, the tabs including the tab being created and at least one existing tab in the tab bar; and
determining the tab style according to the determined tab width.

8. A terminal, comprising:
a processor;
a memory configured to store instructions executable by the processor;
wherein the processor is configured to perform:
receiving a tab creation request which contains tab content and a theme identification, the theme identification being an identification of a theme currently used in the application;
reading tab attribute information from theme information indicated by the theme identification;
determining a tab style consistent with the theme based on the tab attribute information; and
creating a tab including the tab content in a tab bar based on the tab style.

9. The terminal according to claim 8, wherein the processor is further configured to perform:
identifying the theme information indicated by the theme identification from at least one piece of theme information pre-stored in the application; and
reading the tab attribute information from the identified theme information, the tab attribute information including a width determination rule for determining a width of the tab and a manner for arranging the tab in the tab bar.

10. The terminal according to claim 9, wherein:
the width determination rule is one of determining a tab width according to a width occupied by tab content, or determining to use a pre-determined width as a tab width, and the manner for arranging the tab in the tab bar comprises one of aligning the tab to the left, aligning the tab to the right, and aligning the tab to the center of the tab bar; or
the width determination rule is determining a tab width based on a maximum available width of a tab bar, and the manner for arranging the tab is to arrange the tab in the tab bar in a dispersive manner.

11. The terminal according to claim 10, wherein the width determination rule is to determine the tab width based on a width occupied by tab content, and the processor is further configured to perform:
calculating the tab width based on the tab content; and
determining the tab style according to the tab width.

12. The terminal according to claim 11, wherein the processor is further configured to perform:
calculating a content width occupied by the tab content; and
determining to use the content width as the tab width; or detecting whether the content width is greater than a pre-determined minimum width and smaller than a pre-determined maximum width, determining to use the content width as the tab width if the content width is greater than the pre-determined minimum width and smaller than the pre-determined maximum width, determining to use the pre-determined minimum width as the tab width if the content width is smaller than the pre-determined minimum width, and determining to use the pre-determined maximum width as the tab width if the content width is greater than the pre-determined maximum width.

13. The terminal according to claim 12, wherein the processor is further configured to perform:
comparing an absolute value of a first difference with an absolute value of a second difference, the first difference being acquired by subtracting the content width from the pre-determined minimum width, and the second difference being acquired by subtracting the content width from the pre-determined maximum width;
determining to use the pre-determined maximum width as the tab width if the absolute value of the first difference is greater than the absolute value of the second difference; and
determining to use the pre-determined minimum width as the tab width if the absolute value of the first difference is smaller than the absolute value of the second difference.

14. The terminal according to claim 10, wherein the width determination rule is to determine the tab width based on a maximum available width of a tab bar, and the processor is further configured to perform:
determining the tab width by equally dividing a width of the tab bar based on a total number of tabs of the tab bar, the tabs including the tab being created and at least one existing tab in the tab bar; and
determining the tab style according to the tab width.

15. A non-transitory computer-readable storage medium having stored therein instructions that, when executed by a processor of a mobile terminal, cause the mobile terminal to perform a tab creation method, the method comprising:
receiving a tab creation request which contains tab content and a theme identification of an application, the theme identification being an identification of a theme of the application currently in use;
reading tab attribute information from theme information indicated by the theme identification;
determining a tab style consistent with the theme based on the tab attribute information; and
creating a tab including the tab content in a tab bar based on the tab style.

16. The medium according to claim 15, wherein the reading of the tab attribute information comprises:
identifying the theme information indicated by the theme identification from at least one piece of theme information pre-stored in the application; and
reading the tab attribute information from the identified theme information, the tab attribute information comprising a width determination rule for determining a width of the tab and an manner for arranging the tab in the tab bar.

17. The medium according to claim 15, wherein:
the width determination rule comprises one of determining a tab width based on a width occupied by tab content or determining to use a pre-determined width as a tab width, and the manner for arranging the tab in the tab bar comprises one of aligning the tab to the left, aligning the tab to the right, and aligning the tab to the center of the tab bar; or
the width determination rule is to determine a tab width based on a maximum available width of a tab bar, and the manner for arranging the tab is to arrange the tab in the tab bar in a dispersive manner.

18. The medium according to claim 17, wherein the width determination rule is to determine the tab width based on a width occupied by tab content, and the determining of the tab style comprises:
calculating the tab width based on the tab content; and
determining the tab style based on the tab width.

19. The medium according to claim 18, wherein the calculating of the tab width comprises:
calculating a content width occupied by the tab content; and
determining to use the content width as the tab width; or detecting whether the content width is greater than a pre-determined minimum width and smaller than a pre-determined maximum width, determining to use the content width as the tab width if the content width is greater than the pre-determined minimum width and smaller than the pre-determined maximum width, determining to use the pre-determined minimum width as the tab width if the content width is smaller than the pre-determined minimum width, and determining to use the pre-determined maximum width as the tab width if the content width is greater than the pre-determined maximum width.

20. The medium according to claim 19, wherein the determining to use the pre-determined minimum width or the pre-determined maximum width as the tab width comprises:
comparing an absolute value of a first difference with an absolute value of a second difference, the first difference being acquired by subtracting the content width from the pre-determined minimum width, and the second difference being acquired by subtracting the content width from the pre-determined maximum width;
determining to use the pre-determined maximum width as the tab width if the absolute value of the first difference is greater than the absolute value of the second difference; and
determining to use the pre-determined minimum width as the tab width if the absolute value of the first difference is smaller than the absolute value of the second difference.
